(19) United States
(12) Patent Application Publication
(10) Pub. No.: US 2010/0278139 A1
(43) Pub. Date: Nov. 4, 2010

(54) RESOURCE SCHEDULING METHOD AND DEVICE

(75) Inventors: Guangyi Liu, Beijing (CN); Wenqi Liao, Beijing (CN); Lu Han, Beijing (CN); Yuhong Huang, Beijing (CN)

Correspondence Address: VENABLE LLP, P.O. BOX 34385, WASHINGTON, DC, 20043-9998, US

(73) Assignee: China Mobile Communications Corporation, Xicheng District (CN)

(21) Appl. No.: 12/740,833

(22) PCT Filed: Oct. 23, 2008
(86) PCT No.: PCT/CN2008/001793

§ 371 Date: Apr. 30, 2010

(30) Foreign Application Priority Data
Nov. 2, 2007 (CN) 200710176788.1

(51) Int. Cl. H04W 72/12

(52) U.S. Cl. 370/330

(57) ABSTRACT

A resource scheduling method and device. The resource scheduling method includes: scheduling jointly at least two uplink or downlink time slots as a scheduling unit; and indicating resource allocation information of the jointly scheduled time slots in one resource allocation indicating process. With the invention, plural time slots can be scheduled jointly, and resource allocation information of the jointly scheduled time slots can be indicated in one resource allocation indicating process when performing the resource allocation indication to thereby reduce the number of resource allocation indications and further save an overhead of the system to perform the resource allocation indication.

### CROSS-REFERENCE TO RELATED APPLICATIONS

The present application claims the benefit of priority to International Patent Application No. PCT/CN2008/001793 filed 23 Oct. 2008, which further claims the benefit of priority to Chinese patent Application No. 200710176788.1 filed 2 Nov. 2007, the contents of which are incorporated herein by reference in their entirety.

### FIELD OF THE INVENTION

The present invention relates to the field of radio communications and particularly to a resource scheduling method and device applicable to a time or frequency division duplex system.

### BACKGROUND OF THE INVENTION

In a radio communication system, a period at which uplink or downlink resources are scheduled is referred to as a TTI, which may vary from one system to another. There is a short transmission delay in a system with a short TTI, but consequently the resource allocation indication is frequent in the system and thus a considerable system overhead is required.

Taking LTE Type 2 Time Division Duplex (TDD) in a TDD system as an example, as illustrated in FIG. 1, a radio frame of LTE Type 2 TDD with a length of 10 ms is divided into two half-frames each of 5 ms, each of which is further divided into seven service time slots with an identical length (675 μs) and three special time slots including a Downlink Pilot Time Slot (DwPTS) with a length of 83.72 μs, a Guard Period (GP) with a length of 50 μs and an Uplink Pilot Time Slot (UpPTS) with a length of 141.28 μs. Each square block with solid lines in FIG. 1 represents a time slot.

In LTE Type 2 TDD, uplink and downlink time and frequency resources are scheduled at a period of 0.675 ms, and the resource allocation for each time slot needs to be instructed separately in the system and thus considerable system processing and signaling overheads are required.

### SUMMARY OF THE INVENTION

Embodiments of the invention disclose a resource scheduling method and device to reduce a system overhead.

According to an embodiment of the invention, a resource scheduling method includes:

scheduling jointly at least two uplink or downlink time slots as a scheduling unit; and

indicating resource allocation information of the jointly scheduled time slots in one resource allocation indicating process.

According to an embodiment of the invention, a resource scheduling device includes:

a scheduling module adapted to schedule jointly at least two uplink or downlink time slots as a scheduling unit; and

an indicating module adapted to indicate resource allocation information of the jointly scheduled time slots in one resource allocation indicating process.

According to the foregoing embodiments of the invention, on one hand, a plurality of time slots are scheduled jointly to increase the length of a scheduling period, and resource allocation information of the jointly scheduled time slots is indicated through one resource allocation indication to implement the resource allocation indication on the other hand to thereby reduce the number of resource allocation indications and further save an overhead of the system to implement the resource allocation indication.

### BRIEF DESCRIPTION OF THE DRAWINGS

FIG. 1 is a schematic diagram showing the structure of time slots in a radio frame of LTE Type 2 TDD in the prior art;

FIG. 2 is a schematic diagram showing the structure of time slots in a radio frame according to an embodiment of the invention;

FIG. 3 is a schematic diagram showing the structure of time slots in a radio frame according to another embodiment of the invention; and

FIG. 4 is a schematic diagram showing the structure of a resource scheduling device according to an embodiment of the invention.

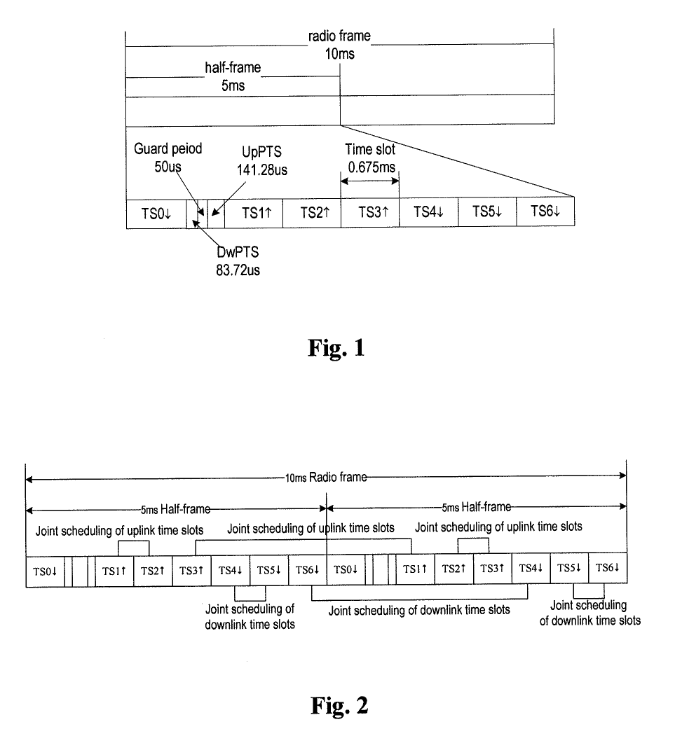

### DETAILED DESCRIPTION OF THE EMBODIMENTS

The embodiments of the invention schedule jointly a plurality of time slots to reduce the system overhead. The embodiments of the invention are detailed hereinafter with reference to the drawings.

In an embodiment of the invention, a resource scheduling process is described by taking a 10 ms radio frame of an LTE Type 2 TDD system as an example, with a ratio of uplink time slots to downlink time slots of the radio frame being 3:4.

FIG. 2 is a schematic diagram showing the structure of time slots in a radio frame according to an embodiment of the invention, and the 10 ms radio frame illustrated in FIG. 2 includes two 5 ms half-frames (also referred to as 5 ms frames), each of which includes a downlink time slot TS0, three uplink time slots TS1, TS2 and TS3 and three downlink time slots TS4, TS5 and TS6 in the order as listed.

During uplink scheduling, the time slots TS1 and TS2 in the former 5 ms frame are paired (as illustrated with a connection link in FIG. 2), the time slots TS2 and TS3 in the latter 5 ms frame are paired (as illustrated with a connection link in FIG. 2), and the time slot TS3 in the former 5 ms frame and the time slot TS1 in the latter 5 ms frame are paired (as illustrated with a connection link in FIG. 2). During uplink transmission of data information, the foregoing every two paired time slots are scheduled as a scheduling unit, i.e., scheduled jointly. The scheduling period is set as two time slots. In order to indicate resource allocation, the system indicates resource allocation of the foregoing two paired time slots as a whole, that is, the system indicates resource allocation information of the jointly scheduled time slots in a single resource allocation indicating process. As can be apparent, indicating the resource allocation information of the jointly scheduled two time slots through a single resource allocation indication in the present embodiment saves an overhead of downlink control signaling as compared to indicating the resource allocation information of the two time slots through two separate resource allocation indications in the prior art.

During joint scheduling of the uplink time slots, due to a relatively small temporal span of the two time slots TS1 and TS2 paired in the former 5 ms frame, the two time slots TS1 and TS2 can be preferentially used to transmit a service (e.g., a real time service) or information (e.g., control information) with a low delay tolerance, that is, the system schedules a data packet of the service with a low delay tolerance preferentially into the two time slots TS1 and TS2 and allocates time and frequency resources to the data packet of the service with a low delay tolerance. Alike, the time slots TS2 and TS3 paired in the latter 5 ms frame can also be preferentially used to transmit a service or information with a low delay tolerance. The two time slots paired across the two 5 ms frames (i.e., the time slot TS3 in the former 5 ms frame and the time slot TS1 in the last 5 ms frame) can be preferentially used to transmit a service with a high delay tolerance (e.g., a non-real time service) due to a relatively large temporal span of 4.325 ms, i.e., a period of time 4.325 ms required for each transmission of data, that is, the system schedules a data packet of the service with a high delay tolerance preferentially into the two time slots paired across the two 5 ms frames and allocates time and frequency resources to the data packet of the service with a high delay tolerance. The forgoing temporal span refers to a temporal span between the first one and the last one of a set of time slots for joint scheduling and can also be represented with a span of time slots.

During downlink scheduling, the time slots TS4 and TS5 in the former 5 ms frame are paired (as illustrated with a connection link in FIG. 2), the time slots TS5 and TS6 in the latter 5 ms frame are paired (as illustrated with a connection link in FIG. 2), and the time slot TS6 in the former 5 ms frame and the time slot TS4 in the latter 5 ms frame are paired (as illustrated with a connection link in FIG. 2). During downlink transmission of data information, the foregoing every two paired time slots are scheduled jointly. The scheduling period is set as two time slots. In order to indicate resource allocation, the system indicates resource allocation information of the foregoing jointly scheduled time slots in a single resource allocation indicating process.

During joint scheduling of the downlink time slots, due to a relatively small temporal span of the two time slots TS4 and TS5 paired in the former 5 ms frame, the two time slots TS4 and TS5 can be preferentially used to transmit a service or information (e.g., control information) with a low delay tolerance, that is, the system schedules a data packet of the service with a low delay tolerance preferentially into the two time slots TS4 and TS5 and allocates time and frequency resources to the data packet of the service with a low delay tolerance. Alike, the time slots TS5 and the TS6 paired in the latter 5 ms frame can also be preferentially used to transmit a service or information with a low delay tolerance. The two time slots paired across the two 5 ms frames (i.e., the time slot TS6 in the former 5 ms frame and the time slot TS4 in the latter 5 ms frame) can be preferentially used to transmit a service with a high delay tolerance due to a relatively large temporal span, that is, the system schedules a data packet of the service with a high delay tolerance preferentially into the two time slots paried across the two 5 ms frames and allocates time and frequency resources to the data packet of the service with a high delay tolerance.

In the present embodiment, the time slot TS0 may not be scheduled jointly with the other downlink time slots because the time slot TS0 is used to transmit control information other than service data.

In another embodiment of the invention, a resource scheduling process is described by taking a 10 ms radio frame of an LTE Type 2 TDD system as an example, with a ratio of uplink time slots to downlink time slots of the radio frame being 3:4.

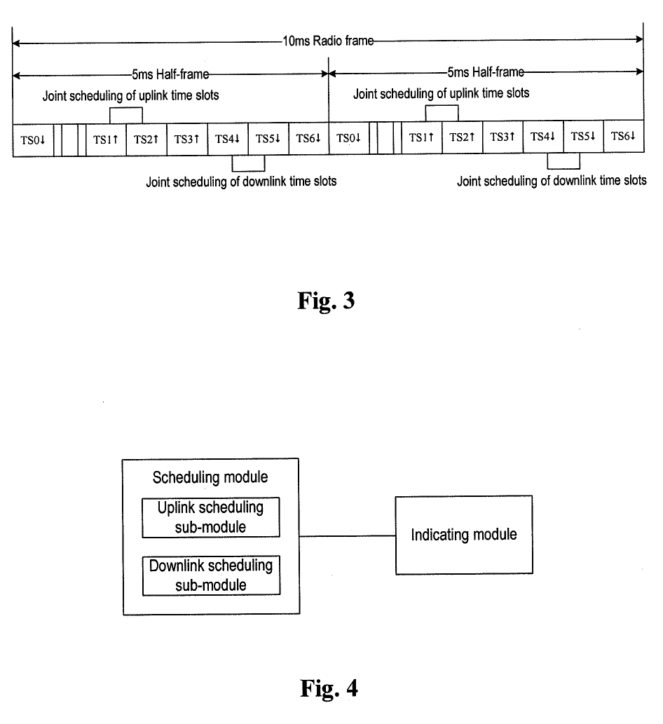

FIG. 3 is a schematic diagram showing the structure of time slots in the radio frame according to the embodiment, and the 10 ms radio frame illustrated in FIG. 3 includes two 5 ms frames, each of which includes a downlink time slot TS0, three uplink time slots TS1, TS2 and TS3 and three downlink time slots TS4, TS5 and TS6 in the order as listed.

During uplink scheduling, the time slots TS1 and TS2 in the former 5 ms frame are paired (as illustrated with a connection link in FIG. 3), and the time slots TS1 and TS2 in the latter 5 ms frame are paired (as illustrated with a connection link in FIG. 3). During uplink transmission of data information, the foregoing every two paired time slots are scheduled jointly, and the unpaired time slots, e.g., the time slot TS3 in the former 5 ms frame and the time slot TS3 in the latter 5 ms frame, are scheduled separately. The every two paired uplink time slots are scheduled at a period of two time slots, and the separately scheduled time slots each are scheduled at a period of one time slot. In order to indicate resource allocation, the system indicates resource allocation information of the jointly scheduled time slots through a single resource allocation indication. As can be apparent, indicating the resource allocation information of the jointly scheduled two time slots in a single resource allocation indicating process in the present embodiment saves an overhead of downlink control signaling as compared to indicating the resource allocation information of the two time slots through two separate resource allocation indications in the prior art.

During joint scheduling of the uplink time slots, the two paired time slots TS1 and TS2 in the former 5 ms frame can be preferentially used to transmit a service or information of a user relatively far from the center of a cell due to a relatively long duration of information transmission (i.e., a relatively long period of scheduling), that is, the system schedules a data packet of the user relatively far from the center of the cell preferentially into the two time slots TS1 and TS2 and allocates time and frequency resources to the data packet of the user relatively far from the center of the cell. Alike, the paired time slots TS1 and TS2 in the latter 5 ms frame can also be preferentially used to transmit a service or information of a user relatively far from the center of a cell. The time slot TS3 scheduled separately in the former 5 ms frame can be preferentially used to transmit a service or information of a user close to the center of a cell due to a relatively short duration of information transmission (i.e., a relatively short period of scheduling), that is, the system schedules a data packet of the user close to the center of the cell preferentially into the time slot TS3 and allocates time and frequency resources to the data packet of the user close to the center of the cell, and the time slot TS3 can also be preferentially used to transmit a service or information with a low delay tolerance. Alike, the time slot TS3 scheduled separately in the latter 5 ms frame can be preferentially used to transmit both a service or information of a user close to the center of a cell and a service or information with a low delay tolerance.

During downlink scheduling, the time slots TS4 and TS5 in the former 5 ms frame are paired (as illustrated with a connection link in FIG. 3), and the time slots TS4 and TS5 in the latter 5 ms frame are paired (as illustrated with a connection link in FIG. 3). During downlink transmission of data information, the foregoing every two paired time slots are scheduled jointly, and the unpaired time slots, e.g., the time slot TS6 in the former 5 ms frame and the time slot TS6 in the latter 5 ms frame, are scheduled separately. The every two paired downlink time slots are scheduled at a period of two time slots, and the separately scheduled time slots each are scheduled at a period of one time slot. In order to indicate resource allocation, the system indicates resource allocation information of the jointly scheduled time slots through a single resource allocation indication.

During joint scheduling of the downlink time slots, the two paired time slots TS4 and TS5 in the former 5 ms frame can be preferentially used to transmit a service or information of a user relatively far from the center of a cell due to a relatively long duration of information transmission, that is, the system schedules a data packet of the user relatively far from the center of the cell preferentially into the two time slots TS4 and TS5 and allocates time and frequency resources to the data packet of the user relatively far from the center of the cell. Alike, the paired time slots TS4 and TS5 in the latter 5 ms frame can also be preferentially used to transmit a service or information of a user relatively far from the center of a cell. The time slot TS6 scheduled separately in the former 5 ms frame can be preferentially used to transmit a service or information of a user close to the center of a cell due to a relatively short duration of information transmission, that is, the system schedules a data packet of the user close to the center of the cell preferentially into the time slot TS6 and allocates time and frequency resources to the data packet of the user close to the center of the cell, and the time slot TS6 can also be preferentially used to transmit a service or information with a low delay tolerance. Alike, the time slot TS6 scheduled separately in the latter 5 ms frame can be preferentially used to transmit both a service or information of a user close to the center of a cell and a service or information with a low delay tolerance.

In the present embodiment, the time slot TS0 is not scheduled jointly with the other downlink time slots because the time slot TS0 is used to transmit control information other than service data.

All the foregoing embodiments have been described by taking paring two time slots for joint scheduling as an example, and in fact more than two time slots can be scheduled jointly in one data frame, for example, the foregoing three uplink time slots TS1, TS2 and TS3 in the 5 ms frame may be scheduled jointly. Alike, more than two time slots may be scheduled jointly across a plurality of data frames, for example, the foregoing time slots TS1, TS2 and TS3 in the former 5 ms frame and time slots TS1, TS2 and TS3 in the latter 5 ms frame may be scheduled jointly. The scheduling period of the jointly scheduled time slots is the total length of the jointly scheduled time slots.

An embodiment of the invention further provides a resource scheduling device which is applicable to a time or frequency division duplex system and which may be integrated in a base station. As illustrated in FIG. 4, the device includes a scheduling module and an indicating module.

The scheduling module is adapted to schedule jointly at least two uplink or downlink time slots as a scheduling unit at a scheduling period which is the total length of the jointly scheduled time slots, and support both the period of scheduling the joint time slots and a scheduling period of scheduling a separate time slot if a data frame further includes the separately scheduled time slot in addition to the jointly scheduled time slots.

The indicating module is adapted to indicate resource allocation information of the jointly scheduled time slots through one resource allocation indication process.

The foregoing scheduling module of the resource scheduling device includes an uplink scheduling sub-module which is adapted to schedule jointly at least two uplink time slots in the same data frame; or is adapted to schedule jointly at least one uplink time slot in a data frame and at least one uplink time slot in another data frame; or is adapted to schedule jointly at least two uplink time slots in a first one of two data frames, schedule jointly at least two uplink time slots in a second one of the two data frames, and schedule jointly at least one of uplink time slots which are not scheduled jointly in the first data frame and at least one of uplink time slots which are not scheduled jointly in the second data frame.

The uplink scheduling sub-module may further be adapted to schedule a data packet of a service or information with a low delay tolerance preferentially into the uplink time slots scheduled jointly in one data frame or the uplink time slot scheduled separately, and schedule a data packet of a service or information with a high delay tolerance preferentially into the uplink time slots scheduled jointly across different data frames; or the uplink scheduling sub-module may be further adapted to schedule a data packet or information of a user close to the center of a cell preferentially into the jointly scheduled uplink time slots with a relatively short scheduling period or a separately scheduled uplink time slot and schedule a data packet or information of a user relatively far from the center of the cell preferentially into the jointly scheduled uplink time slots with a relatively long scheduling period.

The foregoing scheduling module of the resource scheduling device further includes a downlink scheduling sub-module which is adapted to schedule jointly at least two downlink time slots in the same data frame; or is adapted to schedule jointly at least one downlink time slot in a data frame and at least one downlink time slot in another data frame; or is adapted to schedule jointly at least two downlink time slots in a first one of two data frames, schedule jointly at least two downlink time slots in a second one of the two data frames, and schedule jointly at least one of downlink time slots which are not scheduled jointly in the first data frame and at least one of downlink time slots which are not scheduled jointly in the second data frame.

The downlink scheduling sub-module may further be adapted to schedule a data packet of a service or information with a low delay tolerance preferentially into the downlink time slots scheduled jointly in one data frame or the downlink time slot scheduled separately, and schedule a data packet of a service or information with a high delay tolerance preferentially into the downlink time slots scheduled jointly across the different data frames; or the downlink scheduling sub-module may be further adapted to schedule a data packet or information of a user close to the center of a cell preferentially into the jointly scheduled downlink time slots with a relatively short scheduling period or a separately scheduled downlink time slot and schedule a data packet or information of a user relatively far from the center of the cell preferentially into the jointly scheduled downlink time slots with a relatively long scheduling period.

As described above, the foregoing embodiments of the invention provide various flexible methods for scheduling jointly plural time slots in which a plurality of time slots in one 5 ms frame are scheduled jointly as a scheduling unit, or time slots in two 5 ms frames are scheduled jointly as a scheduling unit across different frames, or a plurality of time slots are scheduled jointly both in one 5 ms frame and across 5 ms frames, and the resource allocation information of the jointly scheduled plural time slots is indicated through one resource allocation indication when performing the resource allocation indication to thereby save an overhead of the system to perform the resource allocation indication. Moreover, during joint scheduling of plural time slots, a data packet of a service or information with a low delay tolerance may be transmitted preferentially in the time slots scheduled jointly in one data frame or a time slot scheduled separately, and a data packet of a service or information with a high delay tolerance may be transmitted preferentially in time slots scheduled jointly across different data frames to thereby enable the system to accommodate services with different delay requirements. Moreover, during joint scheduling of plural time slots, a data packet or information of a user close to the center of a cell may be transmitted preferentially in time slots scheduled jointly at a relatively short period or a separately scheduled time slot, and a data packet or information of a user relatively far from the center of the cell may be transmitted preferentially in time slots scheduled jointly at a relatively long period to thereby enable the system to accommodate users with different coverage requirements.

Those ordinarily skilled in the art should appreciate that all or part of the processes in the foregoing method embodiments may be accomplished with relevant hardware instructed by a program, the program may be stored in a computer readable storage medium, e.g., an ROM/RAM, a magnetic disk, an optical disk, etc.

It will be appreciated that one skilled in the art may make various modifications and alterations to the present invention without departing from the spirit and scope of the present invention. Accordingly, if these modifications and alterations to the present invention fall within the scope of the claims of the present invention and their equivalents, the present invention intends to include all these modifications and alterations.

1. A resource scheduling method applicable to a time or frequency division duplex system, comprising:
scheduling jointly at least two uplink or downlink time slots as a scheduling unit; and
indicating resource allocation information of the jointly scheduled time slots in one resource allocation indicating process.

2. The resource scheduling method of claim 1, wherein scheduling jointly the at least two uplink time slots as a scheduling unit comprises:
scheduling jointly at least two uplink time slots in the same data frame; or
scheduling jointly at least one uplink time slot in a data frame and at least one uplink time slot in another data frame; or
scheduling jointly at least two uplink time slots in a first one of two data frames, scheduling jointly at least two uplink time slots in a second one of the two data frames, and scheduling jointly at least one of uplink time slots which are not scheduled jointly in the first data frame and at least one of uplink time slots which are not scheduled jointly in the second data frame.

3. The resource scheduling method of claim 1, wherein scheduling jointly the at least two downlink time slots as a scheduling unit comprises:
scheduling jointly at least two downlink time slots in the same data frame; or
scheduling jointly at least one downlink time slot in a data frame and at least one downlink time slot in another data frame; or
scheduling jointly at least two downlink time slots in a first one of two data frames, scheduling jointly at least two downlink time slots in a second one of the two data frames, and scheduling jointly at least one of downlink time slots which are not scheduled jointly in the first data frame and at least one of downlink time slots which are not scheduled jointly in the second data frame.

4. The resource scheduling method of claim 2, wherein if the data frame further comprises a time slot which is not jointly scheduled, the time slot is scheduled separately.

5. The resource scheduling method of claim 1, wherein joint scheduling further comprises:
scheduling a data packet of a service or information with a low delay tolerance preferentially into the time slots scheduled jointly in one data frame or a time slot scheduled separately, and scheduling a data packet of a service or information with a high delay tolerance preferentially into the time slots scheduled jointly across different data frames; or
joint scheduling further comprises:
scheduling a data packet or information of a user close to the center of a cell preferentially into the jointly scheduled time slots with a relatively short scheduling period or a separately scheduled time slot, and scheduling a data packet or information of a user relatively far from the center of the cell preferentially into the jointly scheduled time slots with a relatively long scheduling period.

6. The resource scheduling method of claim 1, wherein the scheduling period of the jointly scheduled time slots is a total length of the jointly scheduled time slots.

7. A resource scheduling device applicable to a time or frequency division duplex system, comprising:
a scheduling module adapted to schedule jointly at least two uplink or downlink time slots as a scheduling unit; and
an indicating module adapted to indicate resource allocation information of the jointly scheduled time slots in one resource allocation indicating process.

8. The resource scheduling device of claim 7, wherein the scheduling module comprises:
an uplink scheduling sub-module adapted to schedule jointly at least two uplink time slots in the same data frame; or
adapted to schedule jointly at least one uplink time slot in a data frame and at least one uplink time slot in another data frame; or
adapted to schedule jointly at least two uplink time slots in a first one of two data frames, schedule jointly at least two uplink time slots in a second one of the two data frames, and schedule jointly at least one of uplink time slots which are not scheduled jointly in the first data frame and at least one of uplink time slots which are not scheduled jointly in the second data frame.

9. The resource scheduling device of claim 8, wherein the uplink scheduling sub-module is further adapted to schedule a data packet of a service or information with a low delay tolerance preferentially into the uplink time slots scheduled jointly in one data frame or an uplink time slot scheduled separately, and schedule a data packet of a service or information with a high delay tolerance preferentially into the uplink time slots scheduled jointly across different data frames; or
the uplink scheduling sub-module is further adapted to schedule a data packet or information of a user close to the center of a cell preferentially into the jointly scheduled uplink time slots with a relatively short scheduling period or a separately scheduled uplink time slot, and schedule a data packet or information of a user relatively far from the center of the cell preferentially into the jointly scheduled uplink time slots with a relatively long scheduling period.

10. The resource scheduling device of claim 7, wherein the scheduling module comprises:
a downlink scheduling sub-module adapted to schedule jointly at least two downlink time slots in the same data frame; or adapted to schedule jointly at least one downlink time slot in a data frame and at least one downlink time slot in another data frame; or adapted to schedule jointly at least two downlink time slots in a first one of two data frames, schedule jointly at least two downlink time slots in a second one of the two data frames, and schedule jointly at least one of downlink time slots which are not scheduled jointly in the first data frame and at least one of downlink time slots which are not scheduled jointly in the second data frame.

11. The resource scheduling device of claim 10, wherein the downlink scheduling sub-module is further adapted to schedule a data packet of a service or information with a low delay tolerance preferentially into the downlink time slots scheduled jointly in one data frame or a downlink time slot scheduled separately, and schedule a data packet of a service or information with a high delay tolerance preferentially into the downlink time slots scheduled jointly across the different data frames; or
the downlink scheduling sub-module is further adapted to schedule a data packet or information of a user close to the center of a cell preferentially into the jointly scheduled downlink time slots with a relatively short scheduling period or a separately scheduled downlink time slot, and schedule a data packet or information of a user relatively far from the center of the cell preferentially into the jointly scheduled downlink time slots with a relatively long scheduling period.

12. The resource scheduling device of claim 7, wherein the scheduling module schedules jointly the time slots at a scheduling period that is the total length of the jointly scheduled time slots.

13. The resource scheduling method of claim 3, wherein if the data frame further comprises a time slot which is not jointly scheduled, the time slot is scheduled separately.
